(19) United States
(12) Patent Application Publication
(10) Pub. No.: US 2005/0066775 A1
(43) Pub. Date: Mar. 31, 2005

(54) Tattoo needle

(76) Inventor: Cheng Kun Chen, Taipei (TW)

Correspondence Address: BRUCE H. TROXELL, SUITE 1404, 5205 LEESBURG PIKE, FALLS CHURCH, VA, 22041, US

(21) Appl. No.: 10/762,260

(22) Filed: Jan. 23, 2004

(30) Foreign Application Priority Data
Sep. 26, 2003 (TW) 092126723

(51) Int. Cl. B43K 5/00

(52) U.S. Cl. 81/9.22

(57) ABSTRACT

A needle for tattooing the skin or the eyebrow is provided. The needle comprises a sharp end including a tapered portion having a plurality of raised elements (e.g., spaced leftward or rightward curves, quadrilaterals, rough portions, or a combination thereof). Puncturing the skin or the eyebrow with the needle will form a circular hole having an edge with a plurality of indentations therearound for permitting liquid dye to fully flow from the tapered portion thereinto. The invention can achieve the desired tattoo in a shorter period of time with much improved quality.

### BACKGROUND OF THE INVENTION

1. Field of the Invention

The present invention relates to tattoo needles and more particularly to a needle for tattooing the skin or the eyebrow with improved characteristics.

2. Description of Related Art

Skin and eyebrow tattoos are well known. For some people, tattoo is a sign of personalization and/or beauty. A conventional needle for tattooing the skin or the eyebrow is shown in FIG. 1. The needle has a smooth surface as best illustrated in the circular cross-section of a tapered portion near the sharp end 90A thereof. The edge of a hole formed by puncturing the skin with the needle is also circular. The hole may immediately contract due to resilience of the skin. As such, the speed of permeating a dye into the skin is slow and thus the tattoo effect is poor. This means that a long time has to be spent by a person who performs tattoo on a customer. This is not desired.

A prior art tattoo needle disclosed in Taiwanese Patent Published No. 323,469 is shown in FIGS. 2, 3, and 4. There are three configurations of the needle 90 each having three recessed portions 92 extended from a front portion to the sharp end 91. The difference between any two of them is the cross-section. Such configurations aim at facilitating liquid dye to flow along the recessed portions 92 into the skin for coloring. However, the skin may bleed when the skin is punctured by the needle rather than permits the dye to flow into the skin. This can compromise the desired tattoo purpose. Moreover, the sharp end 91 may be more slender due to the provision of the recessed portions 92. This means that the number of lines of the tattoo is decreased. As such, more needles are required in order to obtain the desired tattoo effect on a portion of the skin having a predetermined area. In view of the above, the purpose of shortening tattoo time is not achieved. Further, the manufacturing cost is increased significantly due to the forming of the recessed portions 92 by polishing. Also, the number of the recessed portions 92 is limited due to the small diameter (e.g., about 0.4 mm) of the needle. Typically, it is very difficult of forming more than three recessed portions 92 in the front portion near the sharp end 91. Thus, the prior art needle is only applicable to form fine lines of the tattoo rather than shortens time and leaves uniform marks or patterns. Thus, the need for improvement still exists.

### SUMMARY OF THE INVENTION

It is an object of the present invention to provide a needle for tattooing the skin or the eyebrow, the needle comprising a sharp end including a tapered portion having a plurality of raised elements (e.g., spaced leftward or rightward curves, quadrilaterals, rough portions, or a combination thereof). Puncturing the skin or the eyebrow with the needle will form a circular hole having an edge with a plurality of indentations therearound for permitting liquid dye to fully flow from the tapered portion thereinto. By utilizing the present invention, it is possible of achieving the desired tattoo in a shorter period of time with much improved quality.

It is another object of the present invention to provide a tattoo needle having a sharp end being manufactured by a simple polishing tool while obtaining the above benefits.

The above and other objects, features and advantages of the present invention will become apparent from the following detailed description taken with the accompanying drawings.

### BRIEF DESCRIPTION OF THE DRAWINGS

FIG. 1 is a cross-sectional view of a conventional tattoo needle;

FIGS. 2, 3, and 4 are perspective views in part section of three configurations of the sharp end of another conventional tattoo needle;

FIG. 5 is a perspective view of six configurations of a preferred embodiment of tattoo needle according to the invention;

FIGS. 6, 7, and 8 are perspective views of the sharp ends of three configurations shown in FIG. 5;

FIG. 9 is a cross-sectional view of the sharp end of the needle shown in FIG. 6 or 7;

FIG. 10 is a perspective view of the sharp end of a fourth configuration shown in FIG. 5;

FIG. 11 is a cross-sectional view of the sharp end of the needle shown in FIG. 10;

FIGS. 12 and 13 are perspective views of the sharp ends of fifth and sixth configurations shown in FIG. 5;

FIG. 14 is a cross-sectional view of the sharp end of the needle shown in FIG. 12 or 13; and

FIGS. 15, 16, and 17 are plan views of another three configurations according to the invention, where two, three, and five sharp ends of the needle are fastened together by soldering.

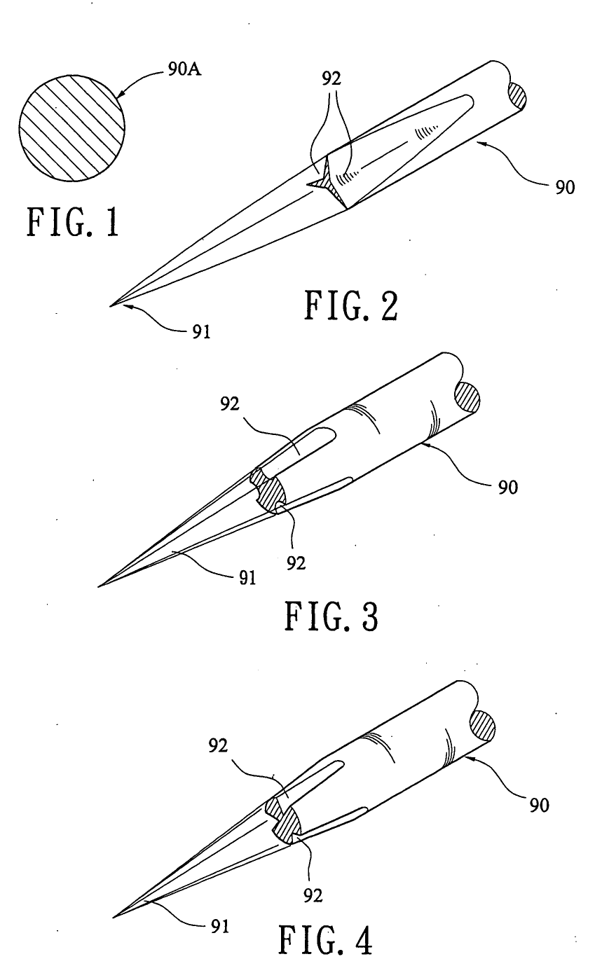

### DETAILED DESCRIPTION OF THE PREFERRED EMBODIMENTS

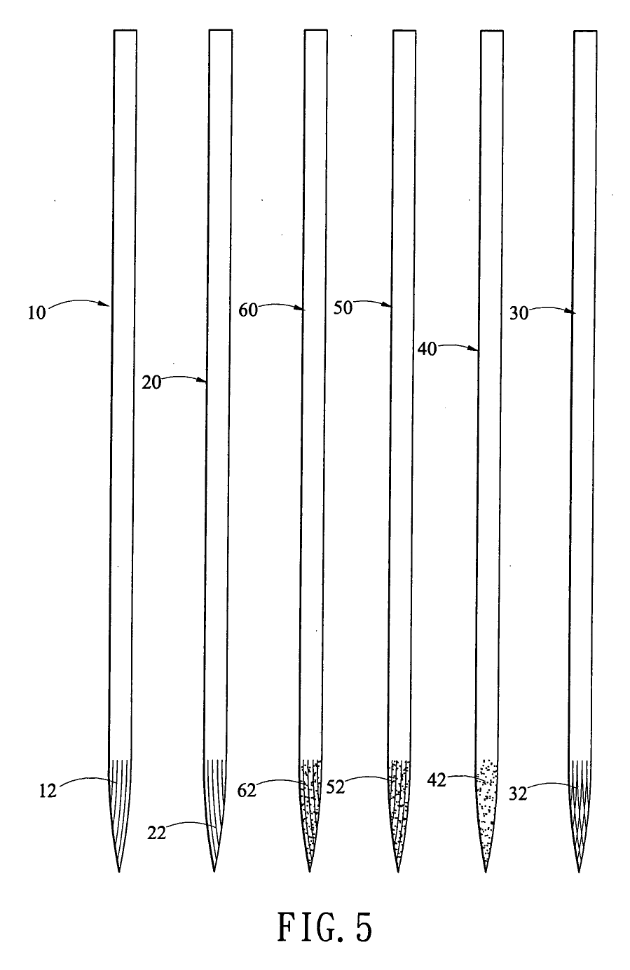

Referring to FIGS. 5, 6, 7, 8, 10, 12, and 13, a needle for tattooing the skin or the eyebrow constructed in accordance with the invention is shown. The needle 10, 20, 30, 40, 50, or 60 comprises a sharp end 12, 22, 32, 42, 52, or 62 having a tapered portion 14, 24, 34, 44, 54, or 64.

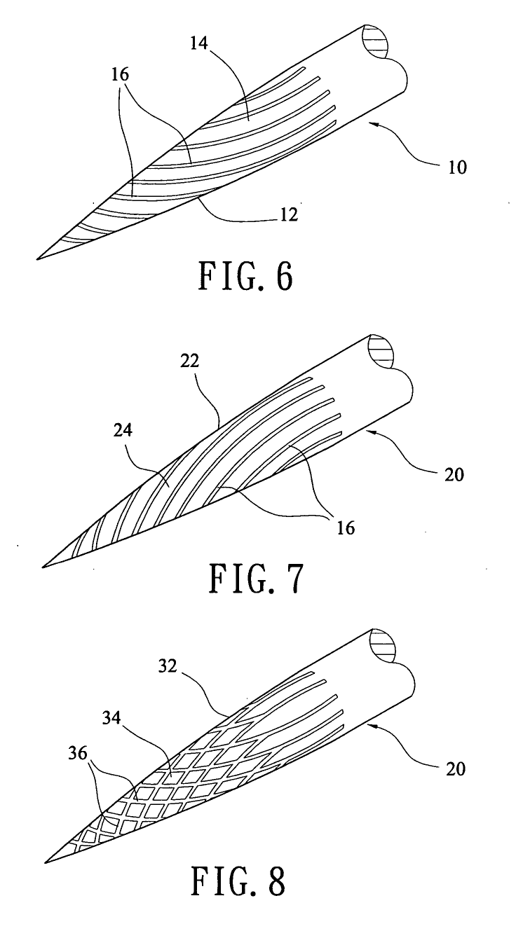

As shown in FIG. 6 specifically, the tapered portion 14 has a plurality of raised elements 16 thereon. The raised elements 16 are implemented as a plurality of spaced, rightward curves 16 formed by rightward polishing the sharp end 12 by a simple polishing tool.

As shown in FIG. 7 specifically, the tapered portion 24 has a plurality of raised elements 26 thereon. The raised elements 26 are implemented as a plurality of spaced, with leftward curves formed by leftward polishing the sharp end 22 by a simple polishing tool.

As shown in FIG. 8 specifically, the tapered portion 34 has a plurality of raised elements 36 thereon. The raised elements 36 are implemented as a plurality of quadrilaterals formed by, for example, intersecting the rightward curves of FIG. 6 and the leftward curves of FIG. 7.

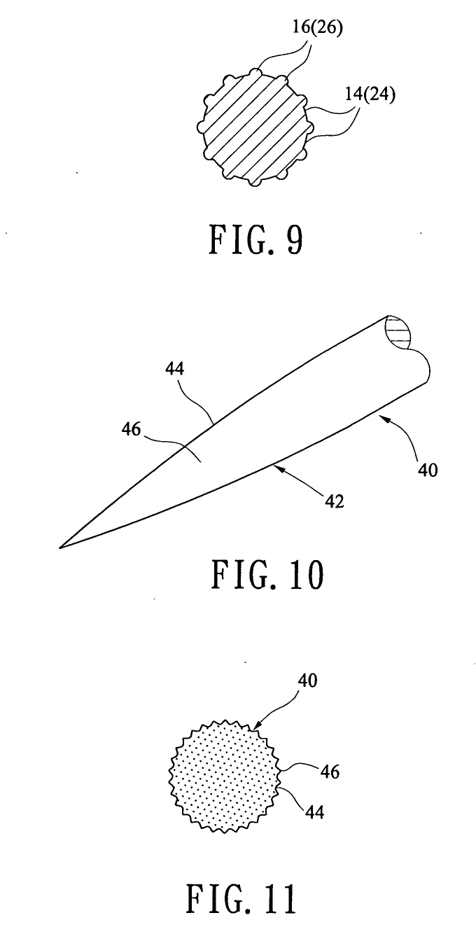

Referring to FIG. 9, in the cross-sectional view of the needle 10 (or 20), the raised elements 16 (or 26) of the tapered portion 14 (or 24) are a loop of toothed members having a smooth ridge. As such, the edge of a hole formed by puncturing the skin with the needle 10 (or 20) is a circle having a plurality of indentations therearound. Such hole may contract due to resilience of the skin but the speed is much slow so as to permit liquid dye to fully flow from the tapered portion 14 (or 24) into the skin. For comparison, we puncture a portion of the skin having a predetermined area with the needle of the invention and that of the prior art respectively. It is found that the invention can achieve the desired tattoo in a relatively short period of time (i.e., time saving) with much improved quality.

Referring to FIG. 11 in conjunction with FIG. 10, the tapered portion 44 has a plurality of raised elements 46 thereon. The raised elements 46 are implemented as a plurality of raised points forming a rough surface 42. Hence, the edge of a hole formed by puncturing the skin with the needle 40 is a circle having a plurality of continuous indentations therearound.

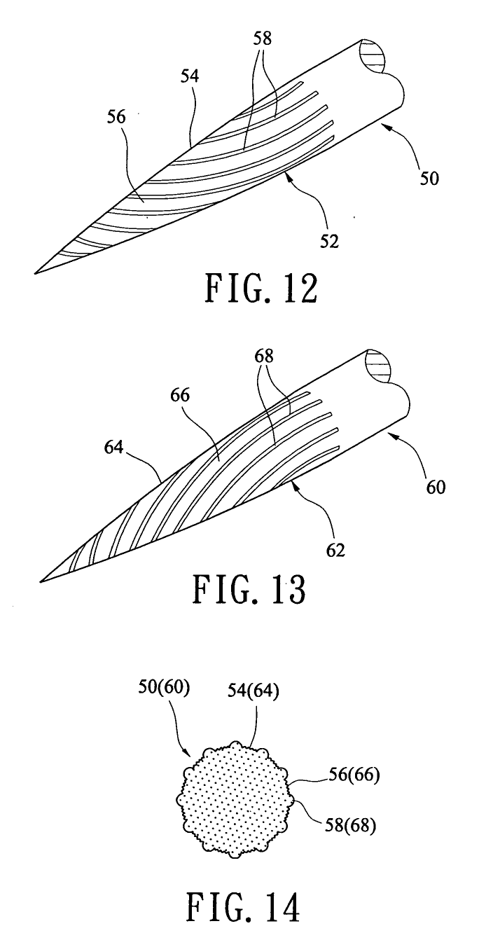

As shown in FIG. 12 specifically, this configuration is a combination of ones shown in FIG. 6 and FIG. 10. That is, the tapered portion 54 has a plurality of spaced, rightward curves 58 disposed on a rough surface 56.

As shown in FIG. 13 specifically, this configuration is a combination of ones shown in FIG. 7 and FIG. 10. That is, the tapered portion 64 has a plurality of spaced, rightward curves 68 disposed on a rough surface 66.

Referring to FIG. 14, in the cross-sectional view of the needle, the raised elements 56 (or 66) of the tapered portion 54 (or 64) are a loop of toothed members having a smooth ridge. As such, the edge of a hole formed by puncturing the skin with the needle is a circle having a plurality of indentations therearound. Such configurations also can achieve the desired tattoo in an improved way substantially the same as or even better than that illustrated in any of above configurations.

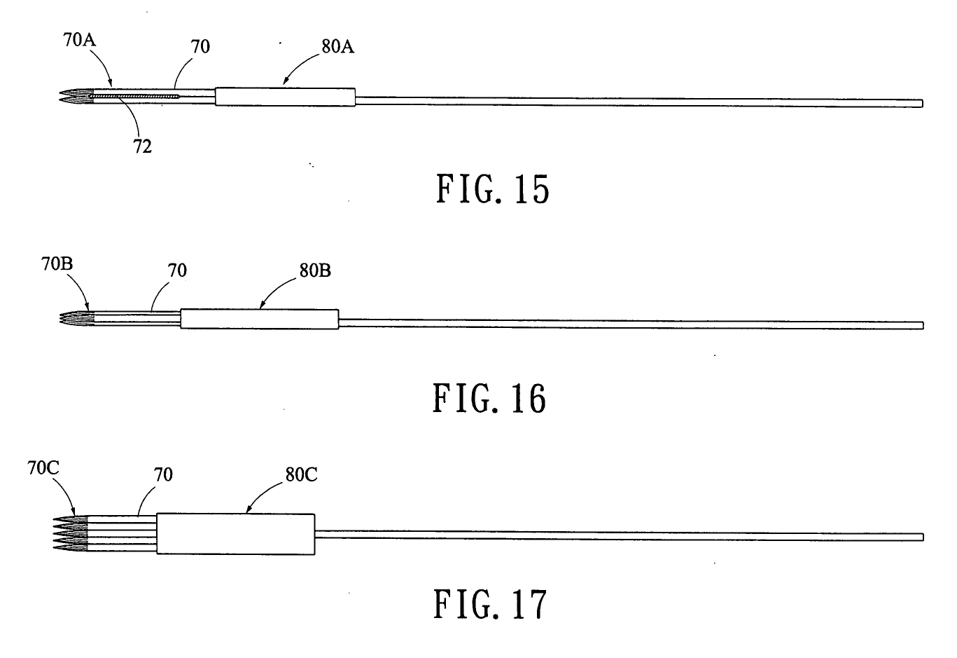

Referring to FIGS. 15 to 17, another three configurations according to the invention are illustrated in which the sharp ends 70A of two needles 70 (FIG. 15), the sharp ends 70B of three needles 70 (FIG. 16), and the sharp ends 70C of five needles 70 (FIG. 17) are fastened together by soldering at a coupled portion of any two adjacent sharp ends. Moreover, a sleeve 80A (FIG. 15), 80B (FIG. 16), and 80C (FIG. 17) is put on rear portions of the sharp ends 70A, 70B, and 70C respectively. Next, the sleeve is subject to heating so as to contract to further fasten the sharp ends 70A, 70B, or 70C together. These configurations can carry out a larger tattoo area per application.

While the invention herein disclosed has been described by means of specific embodiments, numerous modifications and variations could be made thereto by those skilled in the art without departing from the scope and spirit of the invention set forth in the claims.

1. A needle for tattooing the skin or the eyebrow, the needle comprising a sharp end including a tapered portion having a plurality of raised elements thereon, whereby puncturing the skin or the eyebrow with the needle will form a circular hole having an edge with a plurality of indentations therearound for permitting liquid dye to flow from the tapered portion into the skin or the eyebrow.

2. The needle of claim 1, wherein the raised elements are a plurality of spaced curves.

3. The needle of claim 2, wherein the curves are rightward or leftward.

4. The needle of claim 1, wherein the raised elements are a plurality of quadrilaterals formed by intersecting a plurality of spaced rightward curves and a plurality of spaced leftward curves.

5. The needle of claim 1, wherein the raised elements are a plurality of raised points for forming a rough portion thereof.

6. The needle of claim 1, wherein the raised elements are either a plurality of spaced rightward curves disposed on the rough portion or a plurality of spaced leftward curves disposed on a rough portion thereof.

7. The needle of claim 1, wherein the raised elements are a plurality of quadrilaterals formed by intersecting a plurality of spaced rightward curves and a plurality of spaced leftward curves on a rough portion thereof.

8. A plurality of needles for tattooing the skin or the eyebrow fastened together with the sharp end, and a sleeve fastened on rear portions of the sharp ends, one of the needle comprising a sharp end including a tapered portion having a plurality of raised elements thereon, whereby puncturing the skin or the eyebrow with the needle will form a circular hole having an edge with a plurality of indentations therearound for permitting liquid dye to flow from the tapered portion into the skin or the eyebrow.

9. The needle of claim 8, wherein the raised elements are a plurality of spaced curves.

10. The needle of claim 9, wherein the curves are rightward or leftward.

11. The needle of claim 8, wherein the raised elements are a plurality of quadrilaterals formed by intersecting a plurality of spaced rightward curves and a plurality of spaced leftward curves.

12. The needle of claim 8, wherein the raised elements are a plurality of raised points for forming a rough portion thereof.

13. The needle of claim 8, wherein the raised elements are either a plurality of spaced rightward curves disposed on the rough portion or a plurality of spaced leftward curves disposed on a rough portion thereof.

14. The needle of claim 8, wherein the raised elements are a plurality of quadrilaterals formed by intersecting a plurality of spaced rightward curves and a plurality of spaced leftward curves on a rough portion thereof.

15. A needle for tattooing the skin or the eyebrow, the needle comprising a sharp end including a tapered portion having a cross-section of a loop of teeth.
